(19) United States
(12) Patent Application Publication
(10) Pub. No.: US 2026/0127250 A1
(43) Pub. Date: May 7, 2026

(54) ENHANCED POWER SYSTEM INTELLIGENT ELECTRONIC DEVICE LICENSING USING MIDDLEWARE

(71) Applicant: GE Infrastructure Technology LLC, Greenville, SC (US)

(72) Inventors: Bo SU, Markham (CA); Ramu GUDIMETLA, Hyderabad (IN); Marcel MARIAN, Markham (CA); Anca L. CIORACA, Markham (CA)

(73) Assignee: GE Infrastructure Technology LLC, Greenville, SC (US)

(21) Appl. No.: 18/936,400

(22) Filed: Nov. 4, 2024

(51) Int. Cl. G06F 21/10

(52) U.S. Cl. CPC G06F 21/107

(57) ABSTRACT

Devices, systems, and methods for using middleware to manage licenses to applications on intelligent electronic devices (IEDs) for power system equipment. A middleware device may identify activation codes for IEDs of a power system; identify hardware signatures of the IEDs; send a license request, using a software development kit (SDK) application programming interface (API) of the middleware device, to a licensing server or using a web portal to the licensing server, the license request comprising a first activation code of the activation codes and a first hardware signature of a first IED of the IEDs; identify a response file received based on the license request; establish a secure connection with the first IED based on receiving the response file; validate, activate, and extract features from a first license for the first IED based on the response file; and send, using the SDK API, the features to the first IED.

### TECHNICAL FIELD

This disclosure generally relates to intelligent electronic devices for power systems, and more particularly to a middleware-based architecture for controlling licensing of intelligent electronic devices for power systems.

### BACKGROUND

Intelligent electronic devices (IEDs) are computerized protection devices and controllers of power system equipment. Licensing IEDs requires vendor-specific license management software embedded in the IED device being licensed, resulting in a challenging need to update firmware in IED fleets when vendor-specific components require updates, such as for quality and security improvements.

### SUMMARY

A middleware device for managing licenses to applications on intelligent electronic devices (IEDs) for power system equipment, the middleware device may include memory coupled to processing circuitry, wherein the processing circuitry may: identify activation codes for IEDs of a power system; identify hardware signatures of the IEDs; send a license request, using a software development kit (SDK) application programming interface (API) of the middleware device, to a licensing server, the license request comprising a first activation code of the activation codes and a first hardware signature of a first IED of the IEDs; identify a response file received based on the license request; establish a secure connection with the first IED based on receiving the response file; validate a first license for the first IED based on the response file; activate the first license for the first IED based on the response file; extract features of the first license; and send, using the SDK API, the features to the first IED in a vendor-agnostic format to cause the first IED to configure the first license.

A system for managing licenses to applications on intelligent electronic devices (IEDs) for power system equipment, the system including: IEDs of a power system, the IEDs including one or more licensed applications without license vendor code embedded into the IEDs; a web portal; a licensing server storing licenses for the one or more licensed applications; and a middleware device including memory coupled to processing circuitry, wherein the processing circuitry may: identify activation codes for the IEDs; identify hardware signatures of the IEDs; send a license request, using a software development kit (SDK) application programming interface (API) of the middleware device, to the licensing server, the license request including a first activation code of the activation codes and a first hardware signature of a first IED of the IEDs; identify a response file received from the licensing server, based on the license request; establish a secure connection with the first IED based on receiving the response file; validate a first license for the first IED based on the response file; activate the first license for the first IED based on the response file; extract features of the first license; and send, using the SDK API, the features to the first IED in a vendor-agnostic format to cause the first IED to configure the first license.

A method for managing licenses to applications on intelligent electronic devices (IEDs) for power system equipment, the method including: identifying, by processing circuitry of a middleware device, activation codes for IEDs of a power system; identifying, by the processing circuitry, hardware signatures of the IEDs; sending, by the processing circuitry, a license request, using a software development kit (SDK) application programming interface (API) of the middleware device, to a licensing server, the license request including a first activation code of the activation codes and a first hardware signature of a first IED of the IEDs; identifying, by the processing circuitry, a response file received based on the license request; establishing, by the processing circuitry, a secure connection with the first IED based on receiving the response file; validating, by the processing circuitry, a first license for the first IED based on the response file; activating, by the processing circuitry, the first license for the first IED based on the response file; extracting, by the processing circuitry, features of the first license; and sending, by the processing circuitry, using the SDK API, the features to the first IED in a vendor-agnostic format to cause the first IED to configure the first license.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system for managing application licenses of intelligent electronic devices (IEDs) in a grid network using middleware in accordance with one embodiment of the present disclosure.

FIG. 2 illustrates an example system for managing application licenses of IEDs in a grid network using middleware in accordance with one embodiment of the present disclosure.

FIG. 3 illustrates an example process for managing application licenses of IEDs in a grid network using middleware in accordance with one embodiment of the present disclosure.

FIG. 4 is an example system for managing application licenses of IEDs in a grid network using middleware in accordance with one embodiment of the present disclosure.

FIG. 5 shows an offline activation process in accordance with one embodiment of the present disclosure.

FIG. 6 is a diagram illustrating an example of a computing system that may be used in implementing embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

Devices part of a power system, such as relays, switches, transformers, circuit breakers, and the like, may be processor-controlled as intelligent electronic devices (IEDs). Power system IEDs may perform a variety of functions that may be licensed by various parties. IED licensing currently requires a vendor-specific library/software development kit (SDK) embedded in IEDs. Firmware inside of IEDs and other software systems that integrate vendor libraries face challenges when replacing a vendor library, updating a vendor library (e.g., for security and/or quality improvements, or when changing vendors), updating a firmware package on an IED, or changing firmware vendors. The challenge of updating firmware on IEDs is compounded for IED fleets with many (e.g., thousands) of IEDs in a fleet.

The present disclosure introduces a middleware-based solution for IED licensing. Middleware may sit between end units and a license vendor, and may isolate end units from the license vendor. The middleware may be modular and integrated in an engineering tool like an IED configuration, and may operate as a standalone license management tool. The middleware-based solution may be vendor-agnostic, de-coupling license management on a target device (e.g., IED) from a vendor's licensing server by using middleware residing in a separate software tool that receives licenses from a vendor's server, validates the licenses, activates and deactivates the licenses, extracts license features and translates the features to a vendor-agnostic format (e.g., a JavaScript Object Notation JSON format). As a result, the need to embed license vendor code into an IED is eliminated, and IED licensees do not need to update firmware in their IED fleets when a license change or upgrade occurs, when updates may be needed for vendor software, and/or when a vendor changes. In addition, the design, testing, and updating of IED firmware does not need to be performed on all IED end devices for a change in a licensing service, as only the middleware component would need to be updated.

Without the middleware solution herein, when software licenses are applied to IED applications, a license vendor client library/software development kit may be integrated into the IED applications to apply the software licenses. Firmware inside of IEDs may face challenges when replacing a vendor library, updating a vendor library (e.g., for quality and/or security improvements), or updating a firmware package.

The middleware solution herein may manage IED license matters, such as validation, activation, deactivation, and the like. The middleware may be considered an IED digital twin of the software license, and may ensure that device licensing information is secured when the middleware is reinstalled or a different middleware instance is used.

The present disclosure provides a design of a middleware solution which acts as an intermediary layer between device firmware and the vendor's cloud license server. This can provide a level of abstraction and make it easier to switch vendors or libraries in the future if the vendor changed. The present disclosure provides the design of a software license abstraction layer (e.g., a middleware solution) that acts as an intermediary between the device (IED) firmware and various license vendors' servers. This middleware layer aims to achieve vendor independence for the device firmware applications and simplify license management. This way makes it easier to switch vendors or libraries in the future if the vendor changed.

A communication channel between an IED and the middleware may be secured by a gRPC (e.g., remote procedure call framework) and/or TLS (transport layer security protocol). In this manner, the communication may be certificate-based. The middleware user requesting access to an IED may be authenticated and authorized on the IED side, allowing only authorized users to activate, deactivate, and query IED licenses. The middleware may not be responsible for storing licenses. Rather, the licenses may be retrieved from an IED by a middleware instance. The middleware may retrieve license information from a licensing server and compare the retrieved information from the IED using a hardware signature of the licensed IED. The middleware may be secured with a license to prevent users from accessing it.

Procedurally, the middleware may make an API (application programming interface) call to an IED. The API call may be a license request to a licensing server (e.g., using a web portal), including activation codes and a device hardware signature of the IED. The hardware signature may be retrieved through an API call (e.g., to the IED) or from a license server, and may be a serial number of the IED. The middleware may generate activation request files one-by-one. The middleware may upload activation request files through an API call to a licensing server or via a web portal, and may receive the activation response files from the licensing server (e.g., via API call or via the web portal). The middleware may connect to the IED and upload activation response files one-by-one to the IED in a vendor-agnostic format. The middleware may validate a license through the vendor SDK, activate a license through the vendor SDK, and may extract license features and models, and repackage them (e.g., using a vendor-agnostic format). The middleware may return the license features to the IED via an API call.

Therefore, the present disclosure provides a Vendor Agnostic Licensing Method for IEDs with Middleware Software Solution which isolates the target units from the license vendor. License management on the target device is de-coupled from the vendor's licensing server by introducing a middleware component that resides in a separate software tool that receives licenses from the vendor's server, validate license, activate/deactivate licenses, extract license features and translates them to a vendor agnostic format of license features. This eliminates the need to embed license vendor code directly into the target devices. The middleware microservice plays an abstraction layer of software license for end units (any software). The middleware may not store any licensing information, so it can support multiple instances of accessing the same information. As such, a license for an IED is not tied to the Middleware that activated it. The middleware integrates the license vendor library/SDK while the end units never integrate the vendor library/SDK. The middleware connects to cloud license server through online/offline. The middleware is responsible for the license validation, activation/deactivation of the end units. The middleware handle with the software license vendor library/SDK. No matter any change from the license vendors, the middleware may perform actions to adapt these changes, no any impact on the end units. A standard license token interface (e.g., with preset license features) between the middleware and the end units may be used. A set of gRPC APIs may be implemented for software license secure communication between the end units (IEDs) and the middleware.

The above descriptions are for purposes of illustration and are not meant to be limiting. Numerous other examples, configurations, processes, etc., may exist, some of which are described in greater detail below. Example embodiments will now be described with reference to the accompanying figures.

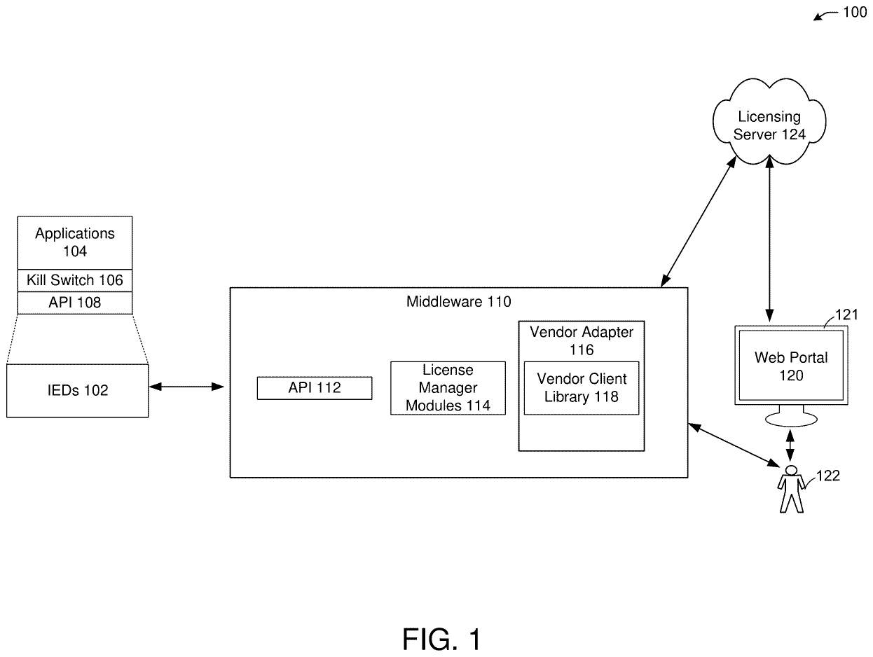

FIG. 1 illustrates an example system 100 for managing application licenses of intelligent electronic devices (IEDs) in a grid network using middleware in accordance with one embodiment of the present disclosure.

Referring to FIG. 1, IEDs 102 (e.g., for a power grid) may include applications 104, a switch 106 (e.g., a shutoff/kill switch for the applications 104), and an API 108 for making and receiving API calls. The middleware 110 may generate and send a request (e.g., a license request as an API call from the API 112) with activation codes and a device hardware signature for the requesting IED. The middleware 110 may include an API 112 with which to send and receive API calls, license manager modules 114 to manage licenses for vendors of the applications 104 on the IEDs 102, and one or more vendor adapters 116, including a vendor client library 118. The middleware 110 may send the license requests using the API 112 or via a web portal 120 (e.g., accessible via a device 121 and by a user 122). A licensing server 124 may provide activation response files based on the hardware signature and the activation codes in the request. Rather than the middleware 110 store licenses for the applications 104, the middleware 110 may retrieve the licenses from the licensing server 124 (e.g., a cloud-based licensing server). The license requests may be sent to the licensing server 124.

The middleware 110 may compare the retrieved license information from the licensing server 124 and compare it with information from the IED 102 by using the hardware signature of the licensed IED. When the user 122 requests access to any of the IEDs 102, the IED may authenticate and authorize the user 122, allowing the user 122 to activate, deactivate, and query licenses (e.g., from the licensing server 124). The middleware 110 may upload activation response files to the IED 102 in a request to the licensing server 124 via API call or via the portal 120. The middleware 110 may validate and activate the license, and may extract license features and business models, via the vendor client library 118. The middleware 110 may return the license features to the IED 102 via an API call.

In one or more embodiments, the vendor adaptor 116 may provide vendor-specific functionalities through the vendor client library 118, may decode license tokens/files using the vendor client library 118 and/or APIs (e.g., relevant for offline model with license files/tokens), extract license features and business models from the license token/file during successful activation, and may translate validation, activation, and deactivation requests into the vendor client library 118. The vendor adaptor 116 also may validate, activate, and/or deactivate a license on behalf of the IED 102 (e.g., via SKD/client library).

In one or more embodiments, the licensing server 124 may act as a central orchestrator, receiving API requests, initiating the validation, activation, and deactivation processes by delegating tasks to an appropriate vendor adaptor, parsing a vendor adapter's response (e.g., validation status or confirmation of activation/deactivation), and relaying the information back to the IED application via API calls.

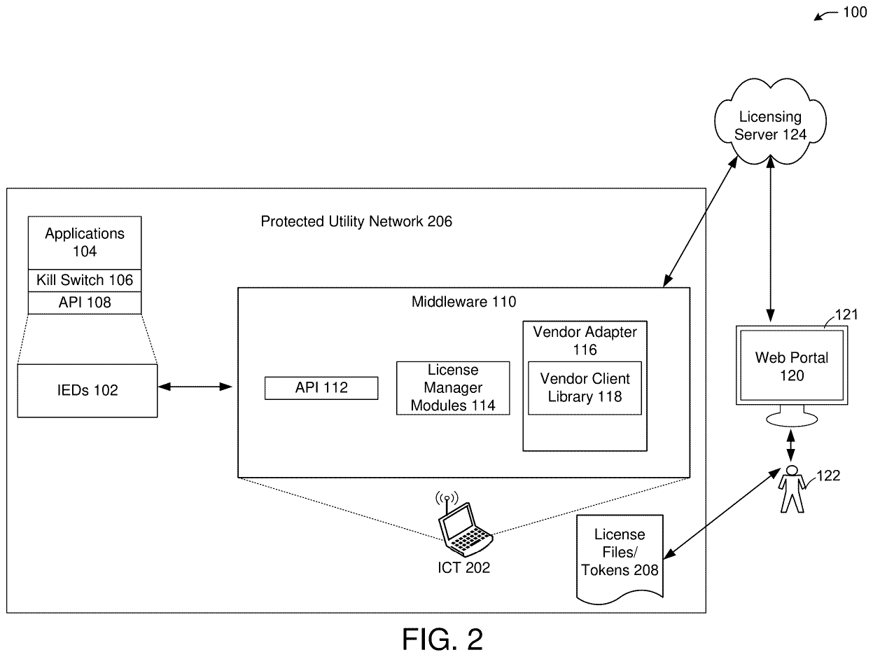

In one or more embodiments, the middleware 110 may be a microservice, modular, or a component integrated into a device (e.g., the ICT 202 of FIG. 2), and may expose the API 112 (e.g., RPC-based) for secure communications with the IED firmware. Instead of the vendor client library and API call being integrated into the IED firmware, the vendor library and API call of IEDs may be moved to the middleware 110 as shown in FIG. 1.

An example JSON format for the license features provided by the middleware 110 to the IEDs 102 may look as follows:

```
{
  “licenseFeatures”: {
  “feature1”: true,
  “feature2”: {
    “subFeatureA”: false,
    “subFeatureB”: “unlimited”
  },
  “feature3”: 100
  },
  “businessModels”: {
  “model1”: “payPerUser”,
  “model2”: {
    “subscriptionType”: “monthly”,
    “costPerUnit”: 10.50
  }
  }
}
```

Another example JSON format with example license features provided by the middleware 110 to the IEDs 102 may look as follows:

```
{
  “licenseId”: “12345-ABCDE-67890-FGHIJ”,
  “deviceId”: “device123”,
  “licenseType”: “SUBSCRIPTION”,
  “issuedDate”: “2024-02-21T10:10:54Z”,
  “expiryDate”: “2025-02-21T10:10:54Z”,
  “features”: {
      “timeBased”: {
              “enabled”: true,
              “duration”: “1Y”
            },
    “featureBased”: {
              “enabled”: true,
              “featuresList”: [
                    “Feature1”,
                    “Feature2”
                    ]
              },
        “trial”: {
              “enabled”: false,
              “duration”: “14D”
          },
        “grace”: {
                “enabled”: false,
                “duration”: “7D”
            },
          “subscription”: {
                “enabled”: true,
                “plan”: “Premium”,
                  “billingCycle”: “1M”
              }
      },
  “status”: “ACTIVE”,
  “licenseKey”: “XXXX-XXXX-XXXX-XXXX”,
  “additionalInfo”: {
  “vendor”: “VendorName”,
  “supportContact”: “support@vendor.com”
  }
}
```

Example API calls between the middleware 110 and the IEDs 102 may look as follows:

GetDeviceSignature( )Return deviceSignature
string deviceSignature;
   ValidateLicense(ValidateLicenseRequest) returns ValidateLicenseResponse:
Request message (ValidateLicenseRequest):
   string licenseToken: The license token to be validated.
Response message (ValidateLicenseResponse):
   bool is Valid: A flag indicating whether the license is valid.
   string errorMessage (optional): An error message if validation fails.
      ActivateLicense(ActivateLicenseRequest) returns ActivateLicenseResponse:
Request message (ActivateLicenseRequest):
   string licenseToken: The license token to be activated.
Response message (ActivateLicenseResponse):
   bool success: A flag indicating successful activation.
   string errorMessage (optional): An error message if activation fails.

### DeactivateLicense(DeactivateLicenseRequest) Returns DeactivateLicenseResponse:

Request message (DeactivateLicenseRequest):
   string licenseToken: The license token to be deactivated.
Response message (DeactivateLicenseResponse):
   bool success: A flag indicating successful deactivation.
   string errorMessage (optional): An error message if deactivation fails.

### GetLicenseFeatures (GetLicenseFeaturesRequest) Returns GetLicenseFeaturesResponse:

Request message (GetLicenseFeaturesRequest):
   string licenseToken: The license token for which to retrieve features.
Response message (GetLicenseFeaturesResponse):
   LicenseFeatures licenseFeatures: A JSON object containing the extracted license features (as defined in the JSON format section).
   string errorMessage (optional): An error message if feature extraction fails.

The GetLicenseFeatures method enables IED applications to request license feature information from the middleware 110. The request message includes the license token, and the response message delivers the extracted features in JSON format along with a potential error message if the extraction fails.

By implementing this gRPC API method, IED applications can interact with the license middleware 110 to obtain the necessary details about the features authorized by the license, simplifying license management within the IED applications.

To ensure security for the middleware 110, the following safety features may be implemented:
Licensing middleware or engineering tool: to secure the engineer's machines with the middleware—this safeguards GE from others using the licensing process on the devices. A library or API-based process can be implemented depending on the security level and the programming language used.
Encryption: All communication between the middleware, firmware, and vendor's server will be encrypted using TLS.
Authentication: Requests from the firmware to the middleware will be authenticated using a secure method, such as HMAC or a digital signature.
Access Control: The middleware will implement access control to ensure that only authorized devices can access the licensing functions. The middleware will be associated with the engineering machine to add an extra layer of security.
Regular Security Audits: The middleware will be regularly audited for security vulnerabilities. Any identified issues will be promptly addressed.

The middleware 110 may include robust error handling and logging capabilities. It may log all interactions with the vendor's server and the IED firmware, and any errors that occur. These logs will be useful for troubleshooting and for identifying any potential issues with the vendor's library or the firmware. The middleware 110 may be designed for scalability and performance. It will be able to handle a number of devices and high volumes of license verification requests. It will also be optimized for low latency to ensure a smooth user experience.

FIG. 2 illustrates an example system 200 for managing application licenses of IEDs in a grid network using middleware in accordance with one embodiment of the present disclosure.

The system 200 includes the system 100 of FIG. 1, and shows in further detail how the middleware 110 may be implemented in an ICT 202 (an IED configurator tool), which may configure the IEDs 102 as defined by the IEC 61850 technical standard or otherwise. The middleware 110 may manage IED application licenses, including their validation, activation, deactivation, and the like, and may act as an IED digital twin of an IED application license. On the IED side, the IEDs 102 may include code to facilitate the return of IED license features.

Still referring to FIG. 2, the IEDs 102 and the middleware 110 may be within a protected utility network 206 that does not allow any application or device within the protected utility network 206 to communicate outside of the protected utility network 206 (e.g., using a firewall or another technique). Communications between the protected utility network 206 and external resources such as the web portal 120 and the licensing server 124 may be facilitated by using a firewall and secured communications utilizing license files/tokens 208.

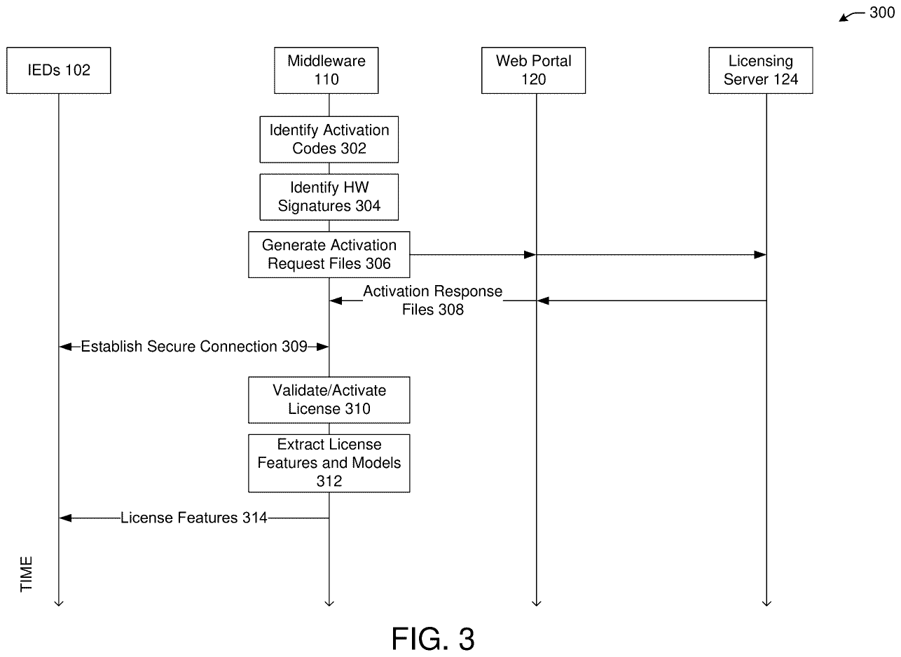

FIG. 3 illustrates an example process 300 for managing application licenses of IEDs in a grid network using middleware in accordance with one embodiment of the present disclosure.

Referring to FIG. 3, the middleware 110 may retrieve activation codes 302 for IEDs to be activated, and may retrieve hardware signature 304 of any of the IEDs 102 where a license is to be activated, deactivated, updated, etc. The middleware 110 may identify the activation codes 302 by requesting them (e.g., via an API call) from the licensing server 124 (e.g., via the web portal 120), or may be programmed with the activation codes 302. The middleware 110 may identify the hardware signatures 304 either by requesting them (e.g., via API calls to the IEDs 102 or to the licensing server 124 via the web portal 120). The middleware 110 may generate (e.g., one by one) activation request files 306 for IED license activations, and may upload the activation request files 306 using the web portal 120 (e.g., as API calls requesting the licensing information for the IEDs identified by the activation codes 302). The web portal 120 may retrieve activation response files 308 from the licensing server 124 based on the activation request files 306, and may make them accessible to the middleware 110.

Still referring to FIG. 3, when the middleware 110 has received the activation response files 308, the middleware 110 may establish a secure connection channel 309 with the IED (e.g., using a certificate-based technique). The middleware 110 may validate and/or activate a license 310. The validation and/or activation 310 may include comparing the licensing information retrieved from the licensing server 124 and comparing it to the retrieved information from the IED based on the hardware signature of the IED in the request 304. The middleware 110 may extract license features and business models 312 from the IED licenses and pack them into a vendor-agnostic format that may be used to provide (e.g., via API call) the license features 314 to the IED for implementation.

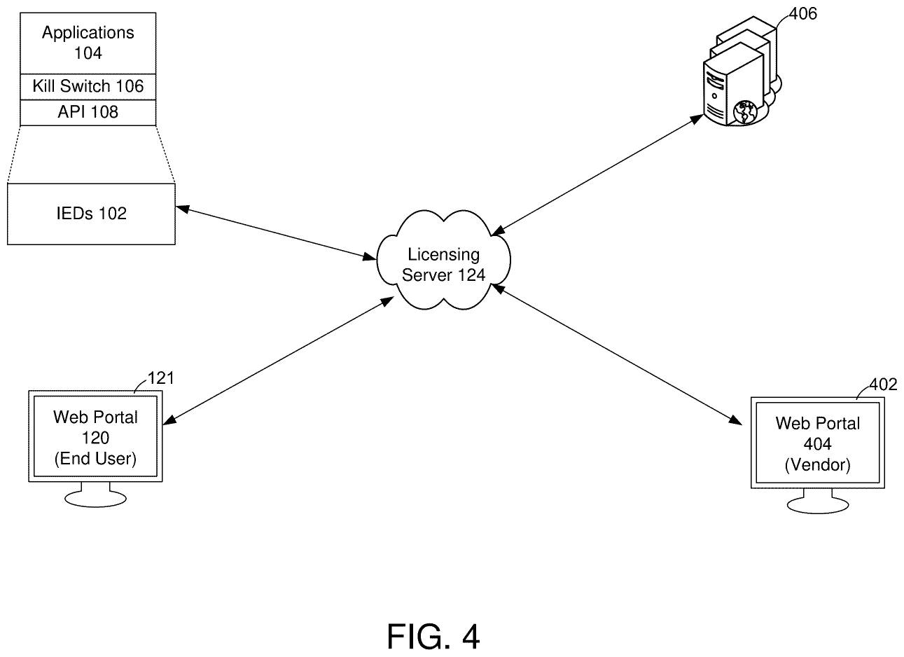

FIG. 4 is an example system 400 for managing application licenses of IEDs in a grid network using middleware in accordance with one embodiment of the present disclosure.

Referring to FIG. 4, the IEDs 102 may exchange API calls with the licensing server 124. Both the web portal 120 as an end user portal and a device 402 providing a vendor web portal 404 may communicate with the licensing server 124, which may may exchange web services API calls with enterprise servers 406. In this manner, the licensing server 124 as a cloud-based licensing server may provide a Software as a Service solution for IED license deployment.

Any software vendor may use the vendor web portal 404 to access the licensing server 124 to configure, set up, and manage licensing activities. For example, the vendor web portal 404 may facilitate vendor functions such as setting up products and business models, setting up internal users, accessing the API and SDK, adding end user customers, setting up the end user web portal 120 (e.g., to allow self-management by users), setting up network deployments (e.g., local licensing server), adding offline activation options, managing customers and entitlements, upselling customers, and driving sales via usage tracking (e.g., based on user consent and in compliance with relevant laws). Once a customer is set up in the licensing server 124, the end user web portal 120 may be established for the customer, and may be accessible to end users to facilitate management of their entitlements and to perform offline license activations and deactivations as described further below.

The licensing vendor for the IED application licenses normally provides web services for integrating the enterprise servers 406. The licensing server 124 may call a licensing API of the enterprise servers 406. To enable a license to work in an IED, the license vendors' library and/or API calls to activate/deactivate licenses may be integrated (e.g., in the middleware 110 as shown in FIG. 1).

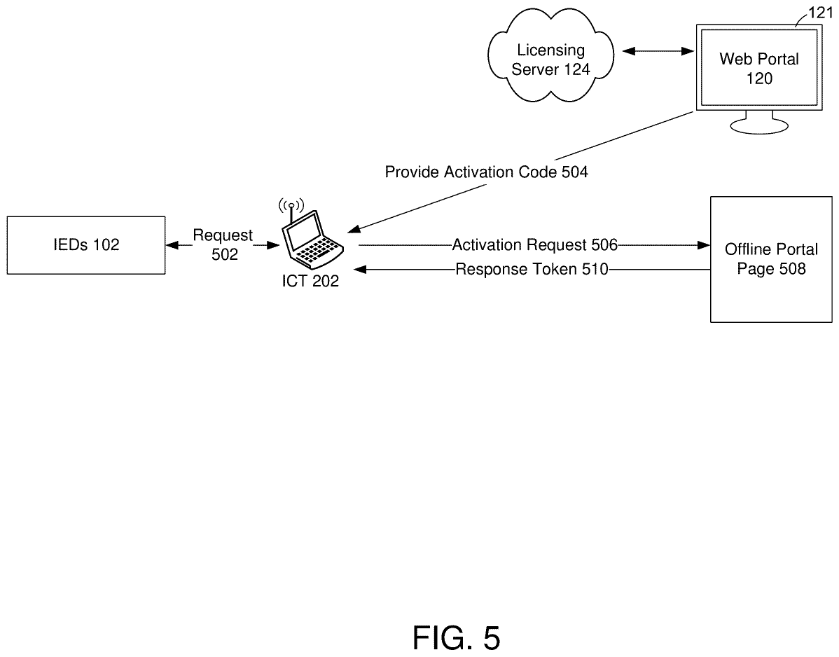

FIG. 5 shows an offline activation process 500 in accordance with one embodiment of the present disclosure.

Referring to FIG. 5, the ICT 202 of FIG. 2 may open the SDK (e.g., the vendor client library 118 of FIG. 1) to issue a license request 502 to the licensing server 124 (e.g., via the end user web portal 120). The end user web portal 120 may paste the previously sourced activation code 504 for the ICT 202, which may copy or save the activation code 504. The ICT 202 may transfer an activation request 506 to an offline portal page 508 (e.g., an offline page of the web portal 120), which may activate the request and copy a response token 510 for the request. The offline page 508 may paste or load from a file the response token 510 for the ICT 202, which may select an offline activation of the response token and cause the response token 510 to be activated.

It is understood that the above descriptions are for purposes of illustration and are not meant to be limiting.

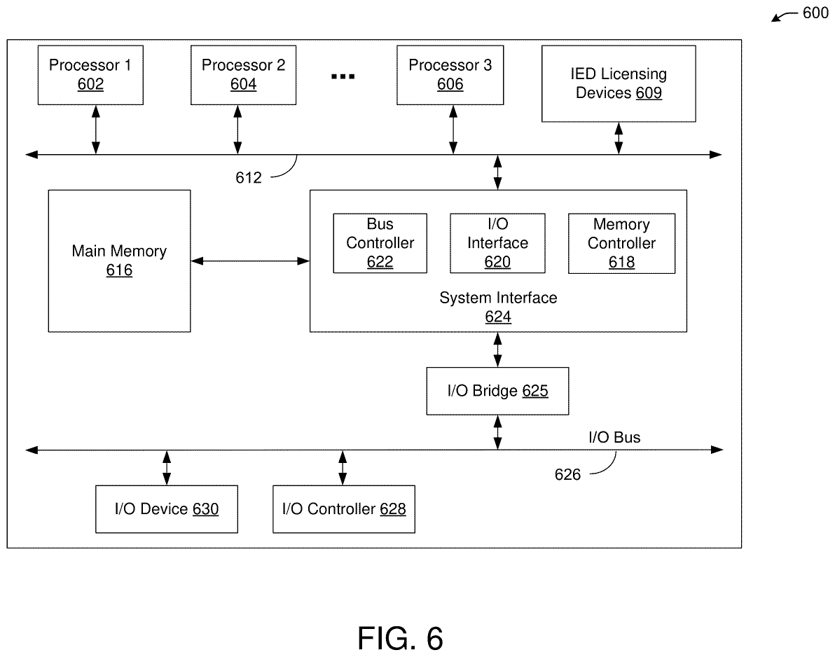

FIG. 6 is a diagram illustrating an example of a computing system 600 that may be used in implementing embodiments of the present disclosure.

The computer system 600 (system) includes one or more processors 602-606 and IED licensing devices 609 (e.g., representing the middleware 110, the components of the IEDs 102, components of the licensing server 124, and components capable of providing the web portal 120 and its user interfaces), capable of performing the functions described for FIGS. 1-5. Processors 602-606 may include one or more internal levels of cache (not shown) and a bus controller 622 or bus interface unit to direct interaction with the processor bus 612. Processor bus 612, also known as the host bus or the front side bus, may be used to couple the processors 602-606 with the system interface 624. System interface 624 may be connected to the processor bus 612 to interface other components of the system 600 with the processor bus 612. For example, system interface 624 may include a memory controller 618 for interfacing a main memory 616 with the processor bus 612. The main memory 616 typically includes one or more memory cards and a control circuit (not shown). System interface 624 may also include an input/output (I/O) interface 620 to interface one or more I/O bridges 625 or I/O devices with the processor bus 612. One or more I/O controllers and/or I/O devices may be connected with the I/O bus 626, such as I/O controller 628 and I/O device 630, as illustrated.

I/O device 630 may also include an input device (not shown), such as an alphanumeric input device, including alphanumeric and other keys for communicating information and/or command selections to the processors 602-606. Another type of user input device includes cursor control, such as a mouse, a trackball, or cursor direction keys for communicating direction information and command selections to the processors 602-606 and for controlling cursor movement on the display device.

System 600 may include a dynamic storage device, referred to as main memory 616, or a random access memory (RAM) or other computer-readable devices coupled to the processor bus 612 for storing information and instructions to be executed by the processors 602-606. Main memory 616 also may be used for storing temporary variables or other intermediate information during execution of instructions by the processors 602-606. System 600 may include a read only memory (ROM) and/or other static storage device coupled to the processor bus 612 for storing static information and instructions for the processors 602-606. The system outlined in FIG. 6 is but one possible example of a computer system that may employ or be configured in accordance with aspects of the present disclosure.

According to one embodiment, the above techniques may be performed by computer system 600 in response to processor 604 executing one or more sequences of one or more instructions contained in main memory 616. These instructions may be read into main memory 616 from another machine-readable medium, such as a storage device. Execution of the sequences of instructions contained in main memory 616 may cause processors 602-606 to perform the process steps described herein. In alternative embodiments, circuitry may be used in place of or in combination with the software instructions. Thus, embodiments of the present disclosure may include both hardware and software components.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in any applicable flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in any flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

The term “interface circuitry” at least in some examples refers to, is part of, or includes circuitry that enables the exchange of information between two or more components or devices. The term “interface circuitry” at least in some examples refers to one or more hardware interfaces, for example, buses, I/O interfaces, peripheral component interfaces, network interface cards, and/or the like.

The term “server” at least in some examples refers to a computing device or system, including processing hardware and/or process space(s), an associated storage medium such as a memory device or database, and, in some instances, suitable application(s) as is known in the art. The terms “server system” and “server” may be used interchangeably herein, and these terms at least in some examples refers to one or more computing system(s) that provide access to a pool of physical and/or virtual resources. The various servers discussed herein include computer devices with rack computing architecture component(s), tower computing architecture component(s), blade computing architecture component(s), and/or the like. The servers may represent a cluster of servers, a server farm, a cloud computing service, or other grouping or pool of servers, which may be located in one or more datacenters. The servers may also be connected to, or otherwise associated with, one or more data storage devices (not shown). Moreover, the servers includes an operating system (OS) that provides executable program instructions for the general administration and operation of the individual server computer devices, and includes a computer-readable medium storing instructions that, when executed by a processor of the servers, may allow the servers to perform their intended functions. Suitable implementations for the OS and general functionality of servers are known or commercially available, and are readily implemented by persons having ordinary skill in the art.

The term “platform” at least in some examples refers to an environment in which instructions, program code, software elements, and the like can be executed or otherwise operate, and examples of such an environment include an architecture (e.g., a motherboard, a computing system, and/or the like), one or more hardware elements (e.g., embedded systems, and the like), a cluster of compute nodes, a set of distributed compute nodes or network, an operating system, a virtual machine (VM), a virtualization container, a software framework, a client application (e.g., web browser or the like) and associated application programming interfaces, a cloud computing service (e.g., platform as a service (PaaS)), or other underlying software executed with instructions, program code, software elements, and the like.

The term “cloud computing” or “cloud” at least in some examples refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like).

The term “virtualization container”, “execution container”, or “container” at least in some examples refers to a partition of a compute node that provides an isolated virtualized computation environment. The term “OS container” at least in some examples refers to a virtualization container utilizing a shared Operating System (OS) kernel of its host, where the host providing the shared OS kernel can be a physical compute node or another virtualization container. Additionally or alternatively, the term “container” at least in some examples refers to a standard unit of software (or a package) including code and its relevant dependencies, and/or an abstraction at the application layer that packages code and dependencies together. Additionally or alternatively, the term “container” or “container image” at least in some examples refers to a lightweight, standalone, executable software package that includes everything needed to run an application such as, for example, code, runtime environment, system tools, system libraries, and settings.

The term “virtual machine” or “VM” at least in some examples refers to a virtualized computation environment that behaves in a same or similar manner as a physical computer and/or a server. The term “hypervisor” at least in some examples refers to a software element that partitions the underlying physical resources of a compute node, creates VMs, manages resources for VMs, and isolates individual VMs from each other.

The term “protocol” at least in some examples refers to a predefined procedure or method of performing one or more operations. Additionally or alternatively, the term “protocol” at least in some examples refers to a common means for unrelated objects to communicate with each other (sometimes also called interfaces). The term “communication protocol” at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like. In various implementations, a “protocol” and/or a “communication protocol” may be represented using a protocol stack, a finite state machine (FSM), and/or any other suitable data structure. The term “standard protocol” at least in some examples refers to a protocol whose specification is published and known to the public and is controlled by a standards body. The term “protocol stack” or “network stack” at least in some examples refers to an implementation of a protocol suite or protocol family. In various implementations, a protocol stack includes a set of protocol layers, where the lowest protocol deals with low-level interaction with hardware and/or communications interfaces and each higher layer adds additional capabilities. Additionally or alternatively, the term “protocol” at least in some examples refers to a formal set of procedures that are adopted to ensure communication between two or more functions within the within the same layer of a hierarchy of functions.

The term “medium access control protocol”, “MAC protocol”, or “MAC” at least in some examples refers to a protocol that governs access to the transmission medium in a network, to enable the exchange of data between stations in a network. Additionally or alternatively, the term “medium access control layer”, “MAC layer”, or “MAC” at least in some examples refers to a protocol layer or sublayer that performs functions to provide frame-based, connectionless-mode (e.g., datagram style) data transfer between stations or devices.

The term “local area network” or “LAN” at least in some examples refers to a network of devices, whether indoors or outdoors, covering a limited area or a relatively small geographic area (e.g., within a building or a campus). The term “wireless local area network”, “wireless LAN”, or “WLAN” at least in some examples refers to a LAN that involves wireless communications.

The term “application” or “app” at least in some examples refers to a computer program designed to carry out a specific task other than one relating to the operation of the computer itself. Additionally or alternatively, term “application” or “app” at least in some examples refers to a complete and deployable package, environment to achieve a certain function in an operational environment.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A middleware device for managing licenses to applications on intelligent electronic devices (IEDs) for power system equipment, the middleware device comprising memory coupled to processing circuitry, wherein the processing circuitry is configured to:
identify activation codes for IEDs of a power system;
identify hardware signatures of the IEDs;
send a license request, using a software development kit (SDK) application programming interface (API) of the middleware device, to a licensing server, the license request comprising a first activation code of the activation codes and a first hardware signature of a first IED of the IEDs;
identify a response file received based on the license request;
establish a secure connection with the first IED based on receiving the response file;
validate a first license for the first IED based on the response file;
activate the first license for the first IED based on the response file;
extract features of the first license; and
send, using the SDK API, the features to the first IED in a vendor-agnostic format to cause the first IED to configure the first license.

2. The middleware device of claim 1, wherein the middleware device is an IED configurator tool (ICT), and wherein the middleware device and the first IED are in a secure network.

3. The middleware device of claim 1, wherein the processing circuitry is further configured to:
send a second license request, using the SDK API, using the web portal, the second licensing request comprising a second activation code of the activation codes and a second hardware signature of a second IED of the IEDs;
identify a second response file received via the web portal based on the second license request;
validate a second license for the second IED based on receiving the second response file;
activate the second license for the second IED based on the response file;
extract second features of the second license;
send, using the SDK API, the second features to the second IED to cause the second IED to configure the second license.

4. The middleware device of claim 1, wherein the first license applies to a first application on the first IED, and wherein the processing circuitry is further configured to:
send a second license request, using the SDK API, using the web portal, the second licensing request comprising a second activation code of the activation codes and the first hardware signature;
identify a second response file received via the web portal based on the second license request;
validate a second license for the first IED based on receiving the second response file;
activate the second license for the first IED based on the response file;
extract second features of the second license;
send, using the SDK API, the second features to the first IED to cause the first IED to configure the second license for a second application on the first IED.

5. The middleware device of claim 1, wherein the processing circuitry is further configured to:
send, using the SDK API, a request for the activation codes,
wherein to identify the activation codes is based on the request for the activation codes.

6. The middleware device of claim 5, wherein the request for the activation codes is sent to the first IED.

7. The middleware device of claim 5, wherein the request for the activation codes is sent to a licensing server via the web portal.

8. The middleware device of claim 1, wherein the processing circuitry is further configured to:
send, using the SDK API, a request for the first hardware signature to the first IED; and
receive the first hardware signature from the first IED based on the request for the first hardware signature.

9. The middleware device of claim 1, wherein the processing circuitry is further configured to establish a connection with a licensing server offline to retrieve license information associated with the first license.

10. The middleware device of claim 1, wherein the SDK API uses a secure Remote Procedure Call (RPC) framework.

11. A system for managing licenses to applications on intelligent electronic devices (IEDs) for power system equipment, the system comprising:
IEDs of a power system, the IEDs comprising one or more licensed applications without license vendor code embedded into the IEDs;
a web portal;
a licensing server storing licenses for the one or more licensed applications; and
a middleware device comprising memory coupled to processing circuitry, wherein the processing circuitry is configured to:
identify activation codes for the IEDs;
identify hardware signatures of the IEDs;
send a license request, using a software development kit (SDK) application programming interface (API) of the middleware device, using the web portal to the licensing server, the license request comprising a first activation code of the activation codes and a first hardware signature of a first IED of the IEDs;
identify a response file received, from the licensing server, based on the license request;
establish a secure connection with the first IED based on receiving the response file;
validate a first license for the first IED based on the response file;
activate the first license for the first IED based on the response file;
extract features of the first license; and
send, using the SDK API, the features to the first IED in a vendor-agnostic format to cause the first IED to configure the first license.

12. The system of claim 11, wherein the middleware device is an IED configurator tool (ICT), wherein the middleware device and the first IED are in a secure network, and wherein the licensing server is external to the secure network.

13. The system of claim 11, wherein the processing circuitry is further configured to:
send a second license request, using the SDK API, using the web portal, the second licensing request comprising a second activation code of the activation codes and a second hardware signature of a second IED of the IEDs;
identify a second response file received via the web portal based on the second license request;
validate a second license for the second IED based on receiving the second response file;
activate the second license for the second IED based on the response file;
extract second features of the second license;
send, using the SDK API, the second features to the second IED to cause the second IED to configure the second license.

14. The system of claim 11, wherein the first license applies to a first application on the first IED, and wherein the processing circuitry is further configured to:
send a second license request, using the SDK API, to a licensing server or using the web portal to the licensing server, the second licensing request comprising a second activation code of the activation codes and the first hardware signature;
identify a second response file received via the web portal based on the second license request;
validate a second license for the first IED based on receiving the second response file;
activate the second license for the first IED based on the response file;
extract second features of the second license;
send, using the SDK API, the second features to the first IED to cause the first IED to configure the second license for a second application on the first IED.

15. The system of claim 11, wherein the processing circuitry is further configured to:
send, using the SDK API, a request for the activation codes,
wherein to identify the activation codes is based on the request for the activation codes.

16. The system of claim 15, wherein the request for the activation codes is sent to the first IED.

17. The system of claim 15, wherein the request for the activation codes is sent to a licensing server via the web portal.

18. The system of claim 11, wherein the processing circuitry is further configured to:
send, using the SDK API, a request for the first hardware signature to the first IED; and
receive the first hardware signature from the first IED based on the request for the first hardware signature.

19. A method for managing licenses to applications on intelligent electronic devices (IEDs) for power system equipment, the method comprising:
identifying, by processing circuitry of a middleware device, activation codes for IEDs of a power system;
identifying, by the processing circuitry, hardware signatures of the IEDs;
sending, by the processing circuitry, a license request, using a software development kit (SDK) application programming interface (API) of the middleware device, to a licensing server or using a web portal to the licensing server, the license request comprising a first activation code of the activation codes and a first hardware signature of a first IED of the IEDs;
identifying, by the processing circuitry, a response file received based on the license request;
establishing, by the processing circuitry, a secure connection with the first IED based on receiving the response file;
validating, by the processing circuitry, a first license for the first IED based on the response file;
activating, by the processing circuitry, the first license for the first IED based on the response file;
extracting, by the processing circuitry, features of the first license; and
sending, by the processing circuitry, using the SDK API, the features to the first IED in a vendor-agnostic format to cause the first IED to configure the first license.

20. The method of claim 19, further comprising:
sending, using the SDK API, a request for the activation codes,
wherein identifying the activation codes is based on the request for the activation codes.
